(19) United States
(12) Patent Application Publication
(10) Pub. No.: US 2026/0312632 A1
(43) Pub. Date: Oct. 8, 2026

(54) METHOD OF CONTROLLING A MULTI-ANTENNA TRANSMITTER AND RECEIVER ARRANGEMENT (MATARA), NON-TRANSITORY COMPUTER-READABLE STORAGE MEDIUM, COMPUTER PROGRAM PRODUCTS, CONTROL UNIT, MATARA, WIRELESS DEVICE AND CHIPS THEREFOR

(71) Applicant: BEAMMWAVE AB, Lund (SE)

(72) Inventors: Joakim Axmon, Limhamn (SE); Bengt Lindoff, Bjärred (SE)

(21) Appl. No.: 19/482,211

(22) PCT Filed: Apr. 11, 2024
(86) PCT No.: PCT/SE2024/050343

§ 371 Date: Nov. 6, 2025

(30) Foreign Application Priority Data
May 8, 2023 (SE) 2330208-6

(51) Int. Cl. H04B 7/0404; H04B 1/00; H04B 1/40

(52) U.S. Cl. CPC H04B 7/0404; H04B 1/0057; H04B 1/40

(57) ABSTRACT

A method of controlling a Multi-Antenna Transmitter and Receiver Arrangement, MATARA, wherein the MATARA is comprisable in a wireless device, WD, and comprises a first plurality of transceivers the method comprising: configuring a first PLL to control center frequency generation for a first set of transceivers configuring a second PLL (522) to control center frequency generation for a second set of transceivers receiving by the MATARA, a first radio signal transmitted by a first remote transceiver node, TNode on a first center frequency (CF1) during a first time period (T1); configuring a (second) plurality of spatio-temporal filters with a first set of filter coefficients; determining whether reception, by the MATARA, of a second radio signal transmitted by a second remote TNode at a second center frequency (CF2), different from the first center frequency (CF1), during a second time period (T2) following the first time period, is necessary; determining whether reception, by the MATARA, of the first radio signal at a third center frequency (CF3), different from the second center frequency (CF2), during a third time period (T3) following the second time period (T2), is necessary; upon determining that reception of the second radio signal at the second center frequency (CF2) during the second time period (T2) and reception of the first radio signal at the third center frequency (CF3) during the third time period (T3) is necessary, configuring the (second) plurality of spatio-temporal filters with a second set of filter coefficients, wherein the second set of filter coefficients is selected so that signals from the first set of transceivers are only combined with signals from the first set of transceivers and signals from the second set of transceivers are only combined with signals from the second set of transceivers. Corresponding computer program product, control unit, MATARA, wireless device, and chips are also disclosed.

### TECHNICAL FIELD

The present disclosure relates to a method of controlling a Multi-Antenna Transmitter and Receiver Arrangement (MATARA), a non-transitory computer-readable storage medium, computer program products, a control unit, a MATARA, a wireless device and a chip therefor. More specifically, the disclosure relates to a method of controlling a Multi-Antenna Transmitter and Receiver Arrangement (MATARA), a non-transitory computer-readable storage medium, computer program products, a control unit, a MATARA, a wireless device and a chip as defined in the introductory parts of the independent claims.

### BACKGROUND ART

In prior art distributed antenna systems, operating using MIMO and/or beamforming, the same Local oscillator (LO) frequency is routed to each transceiver (and the associated antenna). The advantage with such a solution is that phase coherency between antennas is easily achieved, e.g., since the LO signal phase is the same for all transceivers. However, routing a high frequency LO signal over large distances on e.g., a printed circuit board (PCB) comes with significant interference and/or efficiency losses especially for frequencies in the millimetre wave (mmW) range and for frequencies higher than mmW.

An efficient solution mitigating or alleviating the PCB routing problem, the efficiency problem and/or the interference problem is to have distributed LO frequency generation, where the LO frequency is generated, e.g., by phase locked loops (PLLs), which may be based on a common low frequency clock signal of around 20-200 MHz, and where each PLL controls the frequency for a respective transceiver and antenna (or for a set of transceivers/antennas). However, with local/distributed LO frequency generation, the respective LO signal phase may be unsynchronized and therefore some kind of phase calibration is needed.

Furthermore, the phase calibration may be lost once the LO frequency changes, e.g., since the respective PLL may be locked onto another phase after the PLL divider setting has been changed.

For mobile devices operating according to cellular communication protocols, such as 5G or similar protocols, transceiver/LO phase calibration may be performed using synchronization or pilot signals transmitted from a base station. After the calibration is performed, the relative LO phases may be determined, and the signals can be combined phase coherently to achieve the beamforming gain.

However, there are situations where the mobile device needs to perform a frequency change (and thereby lose the phase coherency) and perform an action such as decoding (which requires beamforming and phase coherent combining) on another radio frequency directly after the frequency change. An example of such an action is radio resource management (RRM) inter-frequency (or inter-RAT) measurements using measurement gaps, where the mobile device directly after the end of the gap should switch back to the radio frequency on which communication with the base station was made before the gap, and perform decoding and/or other processing. Another example is a bandwidth part (BWP) switch operation, configured by a network node or a transceiver node. Pilot signals that can be used for phase calibration may not exist immediately after the measurement gap, and hence it may not be possible to perform phase calibration.

Hence there is a need for a method and/or an apparatus solving the above-mentioned problems.

U.S. Pat. No. 8,867,648 B2 discloses that trends for MIMO relevant studies include spatiotemporal signal processing technique studies for transmission reliability enhancement and transmission rate improvement. WO 2021/060787 A1 discloses an electronic device that is configured to determine whether a phase locked loop (PLL) circuit is operating normally, thereby preventing component damage in the electronic device, and preventing disconnection from a communication network. Furthermore, U.S. Pat. No. 9,025,690 B2 discloses a receiver in a 2×2 Line of Sight Multiple Input Multiple Output, (LoS MIMO) system. The receiver is arranged to estimate a first (Ŝ1) and a second (Ŝ2) signal on the basis of a first (r1[t]) and a second (r2[t]) signal received from respective first and second transmitters (Tx1, Tx2). Moreover, U.S. Pat. No. 8,121,573 B2 discloses methods and systems for coexistence in a multiband, multi-standard communication system utilizing a plurality of phase locked loops (PLLs). US 2010/0303186 A1 discloses a synchronization circuit including: a first phase-locked loop circuit; a second phase-locked loop circuit; a first output circuit; a second output circuit; a first detection circuit; a second detection circuit; and a control circuit.

### SUMMARY

An object of the present disclosure is to mitigate, alleviate or eliminate one or more of the above-identified deficiencies and disadvantages in the prior art and/or solve at least the above-mentioned problem or other problems.

According to a first aspect there is provided a method of controlling a Multi-Antenna Transmitter and Receiver Arrangement (MATARA), wherein the MATARA is comprisable in a wireless device (WD), the method comprising: configuring a first PLL to control centre frequency generation for a first set of transceivers, the first set of transceivers comprising two or more transceivers of the plurality of transceivers; configuring a second PLL to control centre frequency generation for a second set of transceivers, the second set of transceivers comprising two or more transceivers of the plurality of transceivers (other than the first set of transceivers); receiving, by the MATARA, a first radio signal transmitted by a first remote transceiver node (TNode), on a first centre frequency during a first time period; configuring a (second) plurality of spatio-temporal filters with a first set of filter coefficients; determining whether reception, by the MATARA, of a second radio signal transmitted by a second remote TNode, at a second centre frequency, different from the first centre frequency, during a second time period following the first time period, is necessary; determining whether reception, by the MATARA, of the first radio signal at a third centre frequency, different from the second centre frequency, during a third time period following the second time period, is necessary; upon determining that reception of the second radio signal at the second centre frequency during the second time period and reception of the first radio signal at the third centre frequency during the third time period T is necessary, configuring the (second) plurality of spatio-temporal filters with a second set of filter coefficients, the second set of filter coefficients are selected so that signals from the first set of transceivers are only combined with signals from the first set of transceivers, and signals from the second set of transceivers are only combined with signals from the second set of transceivers.

According to some embodiments, the (first) plurality of transceivers is different in number from the (second) plurality of spatio-temporal filters.

According to some embodiments, the first radio signal received during the first time period and the first radio signal received during the third time period have the same Transmission Configuration Indicator (TCI) state.

According to some embodiments, the second time period is a measurement gap.

According to some embodiments, the MATARA is configured to monitor only a first bandwidth part (BWP) during the first and third time periods and the MATARA is configured to monitor only a second BWP, different from the first BWP, during the second time period.

According to some embodiments, the third centre frequency is the same as the first centre frequency.

According to a second aspect there is provided a program product comprising instructions, which, when executed on at least one processor of a processing device, cause the processing device to carry out the method according to the first aspect or any of the embodiments mentioned herein.

According to a third aspect there is provided a non-transitory computer-readable storage medium storing one or more programs configured to be executed by one or more processors of a processing device, the one or more programs comprising instructions which, when executed by the processing device, causes the processing device to carry out the method according to the first aspect or any of the embodiments mentioned herein.

According to a fourth aspect there is provided a computer program product comprising a non-transitory computer readable medium, having stored thereon a computer program comprising program instructions, the computer program being loadable into a data processing unit and configured to cause execution of the method of the first aspect or any of the above-mentioned embodiments when the computer program is run by the data processing unit.

According to a fifth aspect there is provided a control unit for a Multi-Antenna Transmitter and Receiver Arrangement (MATARA). The MATARA is comprisable in a wireless device (WD) and the MATARA comprises: a first plurality of transceivers configured to receive a first plurality of analog radio signals via a first plurality of antenna units; a plurality of analog to digital converters configured to convert the first plurality of analog radio signals into a first plurality of digital signals; an extraction unit configured to extract reference signals from each of the first plurality of digital signals; a channel analyser configured to determine characteristics for each of the first plurality of digital signals based on the extracted reference signals; a (second) plurality of spatio-temporal filters configured to process the first plurality of digital signals to obtain a (second) plurality of combined signals; a first phase lock loop (PLL); and a second PLL. The control unit is configured to cause: configuration of the first PLL to control the centre frequency generation for a first set of transceivers, the first set of transceivers comprising two or more transceivers of the plurality of transceivers; configuration of the second PLL to control the centre frequency generation for a second set of transceivers, the second set of transceivers comprising two or more transceivers of the plurality of transceivers (other than the first set of transceivers); reception, by the MATARA, of the first radio signal transmitted by a first remote transceiver node (TNode) on a first centre frequency during a first time period; configuration of the (second) plurality of spatio-temporal filters with a first set of filter coefficients; determination of whether reception, by the MATARA, of a second radio signal, different from the first radio signal, transmitted by a second remote TNode, at a second centre frequency, different from the first centre frequency, during a second time period following the first time period, is necessary; determination of whether reception, by the MATARA, of the first radio signal, at a third centre frequency, different from the second centre frequency, during a third time period following the second time period, is necessary; upon determining that reception of the second radio signal at the second centre frequency during the second time period and reception of the first radio signal at the third centre frequency during the third time period is necessary, configuration of the (second) plurality of spatio-temporal filters with a second set of filter coefficients. The second set of filter coefficients are selected so that signals from the first set of transceivers are only combined with signals from the first set of transceivers, and signals from the second set of transceivers are only combined with signals from the second set of transceivers.

According to some embodiments, the (second) plurality of combined signals is equal in number to the (second) plurality of spatio-temporal filters.

According to some embodiments, the (second) plurality of combined signals is different in number from the first plurality of digital signals.

According to some embodiments, the first plurality of transceivers, the first plurality of analog radio signals, the first plurality of antenna units, and the first plurality of digital signals are (all) equal in number.

According to a sixth aspect there is provided a Multi-Antenna Transmitter and Receiver Arrangement (MATARA), the MATARA comprisable in a wireless device (WD), the MATARA, comprising the control unit of the third aspect.

According to some embodiments, the MATARA comprises: a first plurality of transceivers configured to receive a first plurality of analog radio signals via a first plurality of antenna units; a plurality of analog to digital converters configured to convert the first plurality of analog radio signals into a first plurality of digital signals; an extraction unit configured to extract reference signals from each of the first plurality of digital signals; a channel analyser configured to determine characteristics for each of the first plurality of digital signals based on the extracted reference signals; a (second) plurality of spatio-temporal filters configured to process the first plurality of digital signals to obtain a (second) plurality of combined signals; a first phase lock loop (PLL); a second PLL; and optionally the first plurality of antenna units.

According to some embodiments, the MATARA is configured to monitor only a first bandwidth part (BWP) during the first and third time periods, and the MATARA is configured to monitor only a second BWP, different from the first BWP, during the second time period.

According to a seventh aspect there is provided a wireless device (WD) comprising the multi-antenna transmitter and receiver arrangement (MATARA) of the sixth aspect and the first plurality of antenna units.

According to an eighth aspect there is provided a chip comprising the control unit of the fifth aspect or any of the embodiments mentioned herein.

Effects and features of the second, third, fourth, fifth, sixth, seventh, and eighth aspects are fully or to a large extent analogous to those described above in connection with the first aspect and vice versa.

Embodiments mentioned in relation to the first aspect are fully or largely compatible with the second, third, fourth, fifth, sixth, seventh, and eighth aspects and vice versa.

An advantage of some embodiments is that improved receiver performance is achieved after a measurement gap and/or BWP switch.

Another advantage of some embodiments is that power consumption is reduced or optimized (for a wireless device).

A further advantage of some embodiments is that a lower complexity system (e.g., for handling a frequency switch) is provided, e.g., by only updating filter coefficients of the digital interface chip, (DIC).

Yet a further advantage of some embodiments is that low complexity is achieved (or that complexity is reduced), e.g., since transceiver performance for distributed antenna systems with distributed local oscillator frequency generation may be improved/optimized.

Yet another advantage of some embodiments is that implementation is simplified.

Yet another further advantage of some embodiments is that complexity is reduced.

Yet further advantages of some embodiments are simplified circuit design, improved (energy) efficiency, and/or reduced circuit complexity.

The present disclosure will become apparent from the detailed description given below. The detailed description and specific examples disclose preferred embodiments of the disclosure by way of illustration only. Those skilled in the art understand from guidance in the detailed description that changes, and modifications may be made within the scope of the disclosure.

Hence, it is to be understood that the herein disclosed disclosure is not limited to the particular component parts of the device described or steps of the methods described since such apparatus and method may vary. It is also to be understood that the terminology used herein is for purpose of describing particular embodiments only and is not intended to be limiting. It should be noted that, as used in the specification and the appended claims, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps. Moreover, the term “configured” or “adapted” is intended to mean that a unit or similar is shaped, sized, connected, connectable or otherwise adjusted for a purpose.

### BRIEF DESCRIPTIONS OF THE DRAWINGS

The above objects, as well as additional objects, features, and advantages of the present disclosure, will be more fully appreciated by reference to the following illustrative and non-limiting detailed description of example embodiments of the present disclosure, when taken in conjunction with the accompanying drawings.

FIG. 1A is a schematic drawing illustrating a wireless device according to some embodiments;

FIG. 1B is a flowchart illustrating some method steps according to some embodiments;

FIG. 2 is a schematic drawing illustrating a computer readable (storage) medium according to some embodiments;

FIG. 3 is a flowchart illustrating actions/method steps implemented in a multi-antenna transmitter and receiver arrangement (MATARA) and/or by a control unit according to some embodiments;

FIG. 4 is a timing diagram illustrating different frequencies at certain points in time according to some embodiments; and

FIG. 5 is a schematic drawing illustrating a system comprising wireless devices and transceiver nodes according to some embodiments.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

### TERMINOLOGY

Herein is referred to a processor/processing unit. The processor may be a digital processor. Alternatively, the processor may be a microprocessor, a microcontroller, a central processing unit, a co-processor, a graphics processing unit (GPU), a digital signal processor (DSP), an image signal processor, a quantum processing unit, or an analog signal processor. The processing unit may comprise one or more processors and optionally other units, such as a control unit. Thus, the processor may be implemented as a single-processor, a dual-processor system, or a multiprocessor system. Furthermore, the invention can also be practiced in distributed computing environments where certain tasks are performed by remote processing devices that are linked through a communications network, e.g., 5G, to one or more local processors. In a distributed computing environment, program modules can be located in both local and remote memory storage devices. Moreover, some processing (e.g., for the data plane) may be moved to a centralized node, such as a centralized transceiver node (TNode). For example, baseband processing and/or higher layer processing, such as processing at layers above the physical layer, may be moved to a cloud, such as an mmW RAN cloud (wherein processing is performed by cloud processors). Such a (mmW) cloud deployment may bring significant cost savings to the operator due to centralized processing, collaborative radio processing, and availability of cheap commodity hardware.

Herein is referred to a baseband (BB) processor/processing unit. A BB processor is a processor specifically adapted for processing baseband signals/data.

Herein is referred to a control unit. A control unit may be a processor or a processing unit.

Herein is referred to millimetre Wave (mmW) utilization, mmW communication, mmW communication capability and mmW frequency range. The mmW frequency range is from 24.25 Gigahertz (GHz) to 71 GHz or more generally from 24 to 300 GHz. The mmW frequency range may also be referred to as Frequency Range 2 (FR2).

Herein is referred to a chip. A chip is an integrated circuit (chip) or a monolithic integrated circuit (chip) and may also be referred to as an IC, or a microchip.

Herein is referred to a wireless device (WD). A wireless device is any device capable of transmitting or receiving signals wirelessly. Some examples of wireless devices are user equipment (UE), mobile phones, cell phones, smart phones, Internet of Things (IoT) devices, vehicle-to-everything (V2X) devices, vehicle-to-infrastructure (V21) devices, vehicle-to-network (V2N) devices, vehicle-to-vehicle (V2V) devices, vehicle-to-pedestrian (V2P) devices, vehicle-to-device (V2D) devices, vehicle-to-grid (V2G) devices, fixed wireless access (FWA) points, and tablets.

Herein is referred to Quasi Co Location (QCL). According to ERICSSON: “On spatial QCL definition”, 3GPP DRAFT-R 1-1700771, 3RD GENERATION PARTNERSHIP PROJECT (3GPP), MOBILE COMPETENCE CENTRE ; 650, ROUTE DES LUCIOLES ; F-06921 SOPHIA-ANTIPOLIS CEDEX ; FRANCE, vol. RAN WG1, Spokane, WA, USA; 2017-01-16, XP051208292(and herein), QCL is defined as follows: Two antenna ports/units are said to be quasi co-located if properties of the channel over which a symbol on one antenna port/unit is conveyed can be inferred from the channel over which a symbol on the other antenna port/unit is conveyed.

Herein is referred to a Transmission Configuration Indicator (TCI) State. A TCI state contains parameters for configuring a quasi-co-location relationship between one or two downlink reference signals and the Demodulation reference signal (DM-RS) ports of the physical downlink shared channel (PDSCH), the DM-RS port of physical downlink control channel (PDCCH) and/or the channel state information reference signal (CSI-RS) port(s) of a CSI-RS resource.

Herein is referred to Measurement gaps. Measurement gaps are opportunities given to the WD/user equipment (UE) to perform measurements on downlink signals. A WD/UE may not be able to perform inter-frequency or inter-RAT measurements while also (at the same time) transmitting or receiving. Even for intra-frequency measurements, a 5G WD/UE may require measurement gaps if such measurements are to be performed outside the UE's currently active Bandwidth Part (BWP).

Herein is referred to a “transceiver node” (TNode). A TNode may be a radio unit (RRU), a repeater, a wireless node, or a base station (BS), such as a radio base station (RBS), a Node B, an Evolved Node B (eNB) or a gNodeB (gNB). Thus, a TNode may be a network (NW) node. Furthermore, a TNode may be a BS for a neighbouring cell, a BS for a handover (HO) candidate cell, a radio unit (RRU), a distributed unit (DU), another WD (e.g., a remote WD) or a base station (BS) for a (active/deactivated) secondary cell (SCell) or for a serving/primary cell (PCell, e.g., associated with an active TCI state), a laptop, a wireless station, a relay, a repeater device, a reconfigurable intelligent surface, or a large intelligent surface.

Herein is referred to an antenna unit. An antenna unit may be one single antenna.

However, an antenna unit may also be a dual antenna, such as a dual patch antenna with a first (e.g., horizontal) and a second (e.g., vertical) polarization, thus functioning as two separate antennas or an antenna unit having two ports. Moreover, an antenna unit may be an antenna array, e.g., if analog beamforming is performed.

The polarization of an antenna refers to the orientation of the electric field of the radio wave transmitted by it and is determined by the physical structure of the antenna and its orientation. E.g., an antenna composed of a linear conductor (such as a dipole or whip antenna) oriented vertically will result in vertical polarization; if turned on its side the same antenna's polarization will be horizontal.

Herein is referred to “bandwidth part”. A bandwidth part (BWP) is a bandwidth (or a frequency range) configured for a WD. The BWP is a part/portion of the total/full transmission bandwidth and the WD may be configured to monitor only a single BWP (instead of monitoring the full transmission bandwidth), due to the fact that the WD cannot receive the full transmission bandwidth (e.g., due to reduced capability of the WD or due to the WD being in a mode of reduced complexity, or in order to save power, e.g., if the WD has capacity for the full transmission bandwidth). It is also possible for a WD to monitor more than one BWP, e.g., monitor two separate BWPs.

Herein is referred to a centre (central) frequency. In some embodiments, the centre frequency is the frequency in the centre of a bandwidth part (BWP). Furthermore, in some embodiments, the centre frequency is a carrier frequency. Moreover, in some embodiments, e.g., when carrier aggregation is utilized, the centre frequency is the average frequency of a centre frequency of a first BWP and a centre frequency of a second BWP (or the average frequency of a plurality of centre frequencies of different BWPs).

### BASIC CONCEPT

A basic concept of this invention is that, once a frequency change or a PLL reconfiguration is needed, subsets of transceivers still having valid phase calibration of the local oscillator relative each other are obtained/determined and combining/beamforming is only performed within each subset. Combining of signals from transceivers in different subsets is performed first after phase calibration is performed (or after/when phase calibration information is available).

Furthermore, in some embodiments, a digital beamforming architecture is utilized, in which a WD comprises a set of antennas (with respective transceivers), each antenna (with respective transceiver) configured to receive a stream (or an analog radio signal), the WD further comprising a plurality of spatio-temporal filters having filter coefficients, which filter coefficients are determined by extracting (by an extraction unit) information from pilot symbols for all antennas at regular intervals, the spatio-temporal filters configured to combine the streams received by the antennas in order to reduce the number of streams to a lower number of streams or virtual antennas (which are feed to other units for further processing, such as decoding). With this approach the processing power and/or interface transmission rate can be reduced by a factor of 2-32, since the number of streams (N) received by the antennas, e.g., 16-64, can be reduced to a number of streams/virtual antennas (M), e.g., 2-8, without loss of relevant information (and performance).

### EMBODIMENTS

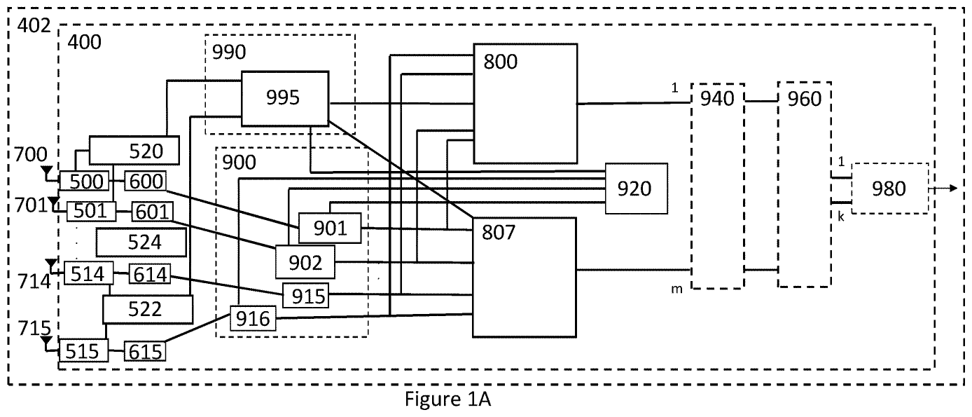

In the following, embodiments will be described where FIG. 1A illustrates a wireless device according to some embodiments and FIG. 1B illustrates some method steps according to some embodiments. The method 100 is for controlling a Multi-Antenna Transmitter and Receiver Arrangement (MATARA) 400. The MATARA 400 is or comprises a multi-antenna receiver arrangement. In some embodiments, the MATARA 400 comprises a multi-antenna transmitter arrangement. In some embodiments, the multi-antenna receiver arrangement is or comprises a multi-antenna unit multiple-input multiple-output (MIMO) receiver arrangement. The MATARA 400 is comprisable or comprised in a wireless device (WD) 402. As seen in FIG. 1A, the MATARA 400 comprises a first plurality N of receivers/transceivers 500, 501, . . . , 515 configured to receive a first plurality (N) of analog radio signals via a first plurality (N) of antenna units 700, 701, . . . , 715 (and optionally configured to transmit a plurality of analog radio signals via the same first plurality of antenna units 700, 701, . . . , 715). In some embodiments, the MATARA 400 comprises the first plurality (N) of antenna units 700, 701, . . . , 715 (for receiving the analog radio signals). Alternatively, the MATARA 400 is connected to the first plurality (N) of antenna units 700, 701, . . . , 715 and the WD 402 comprises the first plurality (N) of antenna units 700, 701, . . . , 715. Furthermore, the MATARA 400 comprises a plurality, e.g., a fourth plurality (I), of analog to digital converters (ADCs) 600, 601, . . . , 615 configured to convert the first plurality (N) of analog radio signals into a first plurality (N) of digital (e.g., baseband) signals. The fourth plurality (I) may be equal to the first plurality (N), i.e., there is one ADC for each receiver/transceiver/analog signal. However, in other embodiments, the fourth plurality is twice as large as the first plurality (i.e., 2N), i.e., there are two ADCs for each analog signal, e.g., one for an in-phase (I) branch and one for a quadrature phase (Q) branch. Moreover, the MATARA 400 comprises an extraction unit 900. The extraction unit 900 is configured to extract reference signals (used for estimating channel characteristics) from each of the first plurality of digital signals. In some embodiments, the extraction unit 900 comprises a first plurality (N) of sub-extraction units 901, 902, . . . , 916, i.e., one sub-extraction unit for each digital signal. The MATARA 400 comprises a channel analyzer/analyser 920. The channel analyzer 920 is configured to determine characteristics, such as one or more filter coefficients, phase shifts and/or delays, for each of the first plurality (N) of digital signals based on the extracted reference signals. Furthermore, the MATARA 400 comprises a (second) plurality m of spatio-temporal filters 800, . . . , 807. The spatio-temporal filters 800, . . . , 807 are configured to process or processes the first plurality (N) of digital signals to obtain a second plurality (m) of combined signals. In some embodiments, the first plurality (N) is larger/greater (in number) than the second plurality (m), i.e., the number of digital signals is larger/greater than the number of combined signals (N>m). Furthermore, in some embodiments, the second plurality (m) is 2 or larger, e.g., 3. In these embodiments, the first plurality (N) is 3 or larger, e.g., 16. Moreover, the MATARA 400 comprises a first phase lock loop (PLL) 520 and a second PLL 522 (and optionally further PLLs, i.e., a plurality of PLLs including a third PLL 524). In some embodiments, the MATARA 400 comprises a transform unit 940. The transform unit 940 is configured to transform or transforms each of the (second) plurality (m) of combined signals into a frequency domain. In some embodiments, the transform unit 940 is or comprises a second plurality (m) of transform sub-units. Each transform sub-unit is configured (connected and otherwise adapted) to process a respective signal of the second plurality (m) of combined signals. In some embodiments, the transform unit transforms each of the combined signals in a serial manner. In some embodiments, a second plurality of transform sub-units process N/m signals each. Furthermore, in some embodiments, the MATARA 400 comprises a post-processing unit 960. The post-processing unit 960 is configured to post-process or post-processes the transformed signals in the frequency domain to obtain a third plurality k of frequency domain processed signals.

Moreover, in some embodiments, the first plurality (N) of analog radio signals is coded. Thus, in some/these embodiments, the MATARA 400 comprises a decoder 980. The decoder 980 is configured to decode or decodes the third plurality (k) of frequency domain processed signals (in order to obtain information signals). In some embodiments, the second plurality (m) is larger/greater than the third plurality (k). Furthermore, the WD 402 comprises a control unit 995. In some embodiments, the control unit is a processor, such as a baseband (BB) processor. Furthermore, in some embodiments, the MATARA 400 is connected or connectable to the control unit 995. Alternatively, the MATARA 300 comprises the control unit 995 (as shown in FIG. 1A). The control unit 995 is connected to and/or configured to control the first and second PLLs 520, 522 (and optionally further PLLs, such as the third PLL 524). Moreover, the control unit 995 is connected to the channel analyser 920. Additionally, or alternatively, the control unit 995 is configured to receive information (e.g., characteristics for each of the first plurality of digital signals) from the channel analyser 920. Furthermore, the control unit 995 is connected to and/or configured to control (e.g., configure with filter coefficients) the spatio-temporal filters 800, . . . , 807 (e.g., in accordance with or based on the, by the channel analyzer 920, determined characteristics). In some embodiments, the MATARA comprises a chip 990, such as a baseband (BB) chip. The chip 990 comprises the control unit 995. In some embodiments, the chip 990 further comprises the extraction unit 900, the (second) plurality of spatio-temporal filters 800, . . . , 807, the ADCs 600, 601, . . . , 615, and optionally one or more of the channel analyser 920, the transform unit 940, the post-processing unit 960, and the decoder 980. By embedding the control unit 995, the extraction unit 900, the (second) plurality of spatio-temporal filters 800, . . . , 807, the ADCs 600, 601, . . . , 615, and optionally one or more of the channel analyser 920, the transform unit 940, the post-processing unit 960, and the decoder 980 in one single chip (e.g., instead of two chips), such as a digital interface chip (DIC), less data needs to be sent from one chip to another (and less interfacing is needed), thus saving power and/or reducing complexity. In some embodiments, the DIC comprises the control unit 995, the extraction unit 900,, the (second) plurality of spatio-temporal filters 800, . . . , 807, the ADCs 600, 601, . . . , 615, and optionally the channel analyser 920, whereas a radio frequency (RF) chip comprises the first plurality (N) of receivers/transceivers 500, 501, . . . , 515 and the plurality of PLLs 520, 522, and a BB chip comprises the transform unit 940, the post-processing unit 960, and the decoder 980 and optionally the channel analyser. Thus, the DIC is (or functions as), in some embodiments, an interface between the BB chip and the RF chip.

Alternatively, the BB chip comprises the control unit 995, the extraction unit 900, the channel analyser 920, the (second) plurality of spatio-temporal filters 800, . . . , 807, the ADCs 600, 601, . . . , 615, the transform unit 940, the post-processing unit 960, and the decoder 980, whereas the RF chip comprises the first plurality (N) of receivers/transceivers 500, 501, . . . , 515 and the plurality of PLLs 520, 522.

Referring to FIG. 1B, the method 100 is a method of controlling a Multi-Antenna Transmitter and Receiver Arrangement (MATARA) 400 (e.g., the MATARA as described above in connection with FIG. 1A). The MATARA 400 is comprisable in a wireless device (WD) 402. Furthermore, the MATARA 400 comprises a first plurality of transceivers 500, 501, . . . , 515. The method 100 comprises configuring 110, by a control unit 995, a first PLL 520 to control centre frequency generation for a first set of transceivers 500, 501. Furthermore, the method 100 comprises configuring 120, by the control unit 995, a second PLL 522 to control centre frequency generation for a second set of transceivers 514, 515. In some embodiments, the first and second sets of transceivers together comprise all the transceivers 500, 501, . . . , 514, 515. Thus, in some embodiments, the first set of transceivers comprises (or consists of) 8 transceivers (500, 501, . . . , 507), and the second set of transceivers comprises (or consists of) 8 transceivers (508, . . . , 514, 515). Alternatively, the control unit 995 configures a plurality of PLLs (e.g., 2, 3, 4, 5, 8, or 16 PLLs) to control centre frequency generation for a plurality of sets (e.g., 2, 3, 4, 5, 8, or 16 sets) of transceivers and the plurality of sets of transceivers together comprise all the transceivers 500, 501, . . . , 514, 515. Thus, in some embodiments (e.g., 16 sets), the first set of transceivers comprises (or consists of) one transceiver (500), and the second set of transceivers comprises (or consists of) one transceiver (515) and in other embodiments, (e.g., 8 sets), the first set of transceivers comprises (or consists of) two transceivers (500, 501), and the second set of transceivers comprises (or consists of) two transceivers (514, 515).

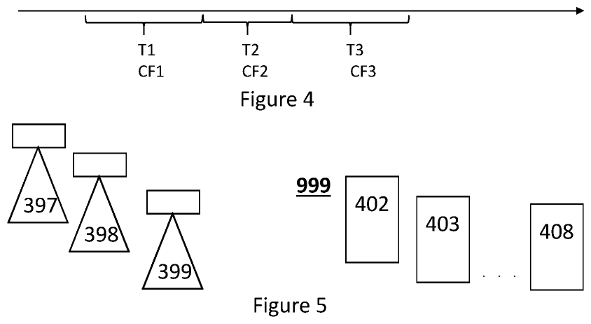

Furthermore, in some embodiments, the plurality of transceivers comprises (or consists of) only 4 transceivers (500, 501, 514, 515) and the first set of transceivers comprises (or consists of) two transceivers (500, 501), and the second set of transceivers comprises (or consists of) two transceivers (514, 515). Furthermore, in some embodiments, the MATARA 400 comprises one PLL for every two transceivers. Moreover, the method 100 comprises receiving 130, by the MATARA 400, a first radio signal transmitted by a first remote transceiver node (TNode) 397 (shown in FIG. 5) on a first centre frequency CF1 during a first time period T1. The method 100 comprises configuring 140, by the control unit 995, a (second) plurality of spatio-temporal filters 800, . . . , 807 with a first set of filter coefficients. Thereby, the (second) plurality of spatio-temporal filters 800, . . . , 807 output a first set of combined signals (e.g., to the transform unit 940). In some embodiments, the first set of filter coefficients is selected so that the signal from each transceiver 500, . . . , 515 is combined with signals from any one or more of the other transceivers 500, . . . , 515. Alternatively (e.g., if the third PLL 524 is not phase calibrated/synchronized with the second or first PLLs 522, 520, but the second and first PLLs 522, 520 are phase calibrated/synchronized with each other), the first set of filter coefficients is selected so that signals from transceivers of a first set of transceivers 500, 501 are only combined with signals from other transceivers of the first set of transceivers 500, 501 and/or with signals from transceivers of a second set of transceivers 514, 515 (and thus not combined with signals from transceivers of a third set of transceivers comprising transceivers for which a third PLL 524 controls centre frequency generation). Furthermore, the method 100 comprises determining 150 whether reception, by the MATARA 400, of a second radio signal transmitted by a second remote TNode 397, 398, 399 at a second centre frequency CF2 during a second time period T2 following the first time period, is necessary. The second centre frequency CF2 is different from the first centre frequency CF1. Furthermore, the second radio signal is different from the first radio signal, i.e., the second radio signal is a different radio signal than the first radio signal. In some embodiments, the second time period T2 is a measurement gap. Furthermore, in some embodiments, the second remote TNode 397, 398, 399 is the first remote TNode 397. Alternatively, the second remote TNode 397, 398, 399 is different from the first TNode 397 (i.e., the second remote TNode 397, 398, 399 is the TNode 398, 399).

Reception of such a second radio signal may be necessary due to a frequency change, e.g., since radio resource management (RRM) inter-frequency or inter-RAT measurements using measurement gaps are needed/scheduled. Alternatively, reception of such a second radio signal may be necessary, since reception on another carrier frequency is needed/scheduled (e.g., if the WD 402 and/or the MATARA 400 supports dual-sim, dual-standby, DSDS, single receive, or has dual-sim capability). As another alternative, reception of such a second radio signal may be necessary since a BWP switch operation is needed/scheduled. The method 100 comprises determining 160 whether reception, by the MATARA 400, of the first radio signal at a third centre frequency CF3 during a third time period T3 following the second time period T2, is necessary. The third centre frequency CF3 is different from the second centre frequency CF2. In some embodiments, the third centre frequency CF3 is the same as the first centre frequency CF1. Reception of the first radio signal at a third centre frequency CF3 may be necessary for the same reasons (given above) as reception of the second radio signal may be necessary. In some embodiments, the first radio signal received during the first time period T1 and the first radio signal received during the third time period T3 are quasi co-located.

Moreover, in some embodiments, the first radio signal received during the first time period T1 and the first radio signal received during the third time period T3 have the same Transmission Configuration Indicator, TCI, state. This (same TCI state) indicates that the first radio signal received during the first time period T1 and the first radio signal received during the third time period T3 are quasi co-located. Furthermore, the method 100 comprises, upon determining that reception of the second radio signal at the second centre frequency CF2 during the second time period T2 and/or reception of the first radio signal at the third centre frequency CF3 during the third time period T3 is necessary, configuring 170 the (second) plurality of spatio-temporal filters 800, . . . , 807 with a second set of filter coefficients. Thereby, the (second) plurality of spatio-temporal filters 800, . . . , 807 output a second set of combined signals (e.g., to the transform unit 940). In some embodiments, the second set of filter coefficients is different from the first set of filter coefficients. The second set of filter coefficients is selected so that signals from the first set of transceivers 500, 501 are only combined (e.g., by a first spatio-temporal filter 800) with signals from the first set of transceivers 500, 501 and signals from the second set of transceivers 514, 515 are only combined (e.g., by a second spatio-temporal filter 807) with signals from the second set of transceivers 514, 515. This may be implemented by setting some of the filter coefficients of the second set of filter coefficients to zero. Thus, the first and second sets of transceivers still have valid phase calibration of the local oscillator relative each other. Hence, an improved receiver/transceiver performance is achieved, the power consumption is reduced and/or a lower complexity system is obtained (for handling a frequency switch). In some embodiments, the method 100 comprises, upon determining that reception of the second radio signal at the second centre frequency (CF2) during the second time period (T2) and that reception of the first radio signal at the third centre frequency (CF3) during the third time period (T3) is not necessary, omitting the step of configuring 170 the (second) plurality of spatio-temporal filters 800, . . . , 807 with a second set of filter coefficients. Alternatively, in some embodiments, the method 100 comprises, upon determining that reception of the second radio signal at the second centre frequency (CF2) during the second time period (T2) is not necessary, omitting the step of configuring 170 the (second) plurality of spatio-temporal filters 800, . . . , 807 with a second set of filter coefficients. As another alternative, the method 100 comprises, upon determining that reception of the first radio signal at the third centre frequency (CF3) during the third time period (T3) is not necessary, omitting the step of configuring 170 the (second) plurality of spatio-temporal filters 800, . . . , 807 with a second set of filter coefficients.

In some embodiments, the MATARA 400 (or the WD 402) is configured to monitor only a first bandwidth part (BWP) during the first and third time periods T1, T3. Furthermore, in some embodiments, the MATARA 400 (or the WD 402) is configured to monitor only a second BWP, different from the first BWP, during the second time period T2. Thus, in some embodiments, the method 100 comprises monitoring, by the MATARA 400 (or the control unit 995 thereof) or by the WD 402, only a first bandwidth part (BWP) during the first and third time periods T1, T3. Alternatively, or additionally, the method 100 comprises monitoring, by the MATARA 400 (or the control unit 995 thereof) or by the WD 402, only a second BWP, different from the first BWP, during the second time period T2. Moreover, in some embodiments, the method 100 comprises transforming 180 each of the (second) plurality (m) of combined signals into a frequency domain (or into a complex frequency domain, e.g., a DFT-domain, an FFT-domain, a Laplace domain, a wavelet domain, or a Z-domain). In some embodiments, the transforming 180 comprises Discrete Fourier Transforming (DFT), Fast Fourier transforming (FFT), Laplace transforming, Wavelet transforming and/or Z-transforming. Preferably, the transforming 180 comprises FFT. By transforming fewer combined signals than received analog radio signals, power consumption and/or complexity is reduced, e.g., since fewer transforms are needed due to fewer channels/streams.

Furthermore, in some embodiments, the method 100 comprises post-processing 185 the transformed signals in the frequency domain to obtain a third plurality k of frequency domain processed signals. The post-processing 185 comprises, in some embodiments, combining the transformed signals in the (complex) frequency domain. Moreover, in some embodiments, the first plurality (N) of analog radio signals is coded, e.g., prior to transmission of the analog radio signals. Thus, in some embodiments, the method 100 comprises decoding 190 the third plurality (k) of frequency domain processed signals. Thus, a third plurality (k) of decoded signals, i.e., information signals, is obtained. In some embodiments, the second plurality is larger than the third plurality, i.e., m is larger than k. By decoding fewer signals than the combined signals, power consumption and/or complexity is reduced, e.g., for the decoding circuits/decoder(s) performing the decoding 180. In some embodiments, the obtained information signals comprising data, images, sound, and/or voice. In some embodiments, the method 100 comprises checking 192 (e.g., after decoding 190 has been performed or after configuring 170 has been performed), by the control unit 995, if phase calibration information is available. Furthermore, in some embodiments, the method 100 comprises, if/when phase calibration information is available, performing 194 phase calibration (and if/when phase calibration information is not available, not performing 194 phase calibration). Moreover, in some embodiments, the third PLL 524 is not phase calibrated with the first and/or second PLLs 520, 522. However, in some embodiments, the third PLL 524 is phase calibrated with the first and/or second PLLs 520, 522. Moreover, in some embodiments, the method 100 comprises, after phase calibration has been performed, configuring 196 the (second) plurality of spatio-temporal filters 800, . . . , 807 with a third set of filter coefficients, wherein the third set of filter coefficients is selected so that signals from the first set of transceivers 500, 501 are combined with signals from the first and/or the second set of transceivers 500, 501, 514, 515 (only) and signals from the second set of transceivers 514, 515 are combined with signals from the first and/or the second set of transceivers 500, 501, 514, 515 (only). E.g., the third set of filter coefficients is selected so that signals from transceivers of a first set of transceivers 500, 501 are only combined with signals from other transceivers of the first set of transceivers 500, 501 and/or with signals from transceivers of a second set of transceivers 514, 515 (and thus not combined with signals from transceivers of a third set of transceivers comprising transceivers for which a third PLL 524 controls centre frequency generation). Alternatively, the third set of filter coefficients is selected so that the signal from each transceiver 500, . . . , 515 is combined with signals from any one or more of the other transceivers 500, . . . , 515. Thereby, the (second) plurality of spatio-temporal filters 800, . . ., 807 output a third set of combined signals (e.g., to the transform unit 940). In some embodiments, the third set of filter coefficients is the same as the first set of filter coefficients. However, in other embodiments, the third set of filter coefficients is different from the first set of filter coefficients, e.g., since the phase shifts for the PLLs are different. In some embodiments, the method 100 comprises repeating 198 the steps 110, 120, 130, 140, 150, 160, 170 and optionally one or more of the steps 180, 185, 190, 192, 194, 196 and monitoring (first and/or second BWP).

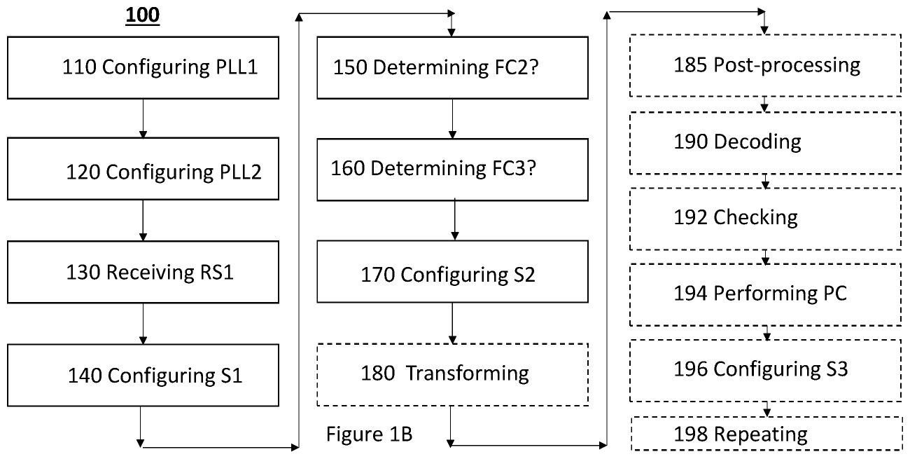

According to some embodiments, a computer program product comprising a non-transitory computer readable medium 200, such as a punch card, a compact disc (CD) ROM, a read only memory (ROM), a digital versatile disc (DVD), an embedded drive, a plug-in card, or a universal serial bus (USB) memory, is provided. FIG. 2 illustrates an example computer readable medium in the form of a compact disc (CD) ROM 200. The computer readable medium has stored thereon, a computer program comprising program instructions. The computer program is loadable into a data processor (PROC) 220, which may, for example, be comprised in a computer or a computing device or the control unit 210. When loaded into the data processor 220, the computer program may be stored in a memory (MEM) 230 associated with or comprised in the data processor 220. According to some embodiments, the computer program may, when loaded into and run by the data processor 220, cause execution of method steps according to, for example, the method illustrated in FIG. 1B, which is described herein. Furthermore, in some embodiments, there is provided a computer program product comprising instructions, which, when executed on at least one processor of a processing device, cause the processing device to carry out the method illustrated in FIG. 1B. Moreover, in some embodiments, there is provided a non-transitory computer-readable storage medium storing one or more programs configured to be executed by one or more processors of a processing device, the one or more programs comprising instructions which, when executed by the processing device, causes the processing device to carry out the method illustrated in FIG. 1B.

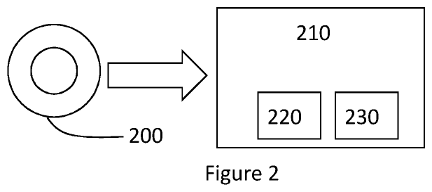

FIG. 3 illustrates actions/method steps caused by the control unit 995 (described above in connection with FIG. 1A) comprised or comprisable in the WD 402 (described above in connection with FIG. 1A). The control unit 995 is for (control of) the MATARA 400 (described above in connection with FIG. 1A). The control unit 995 is configured to cause configuration 310 of the first PLL 520 to control the centre frequency generation for a first set of transceivers 500, 501. To this end, the control unit 995 may be associated with (e.g., operatively connectable, or connected, to) a first configuration unit (e.g., first configuring circuitry, a first configurer). Furthermore, the control unit 210 is configured to cause configuration 320 of the second PLL 522 to control the centre frequency generation for a second set of transceivers 514, 515. To this end, the control unit 995 may be associated with (e.g., operatively connectable, or connected, to) a second configuration unit (e.g., second configuring circuitry, a second configurer). Moreover, the control unit 995 is configured to cause reception 330, by the MATARA 400, of the first radio signal transmitted by a first remote transceiver node, TNode, 398, on a first centre frequency CF1 during a first time period T1. To this end, the control unit 995 may be associated with (e.g., operatively connectable, or connected, to) a receiving unit (e.g., receiving circuitry, a receiver or the MATARA 400, or the transceivers 500, 501, . . . , 514, 515 with respective antenna units 700, 701, . . . , 714, 715). The control unit 995 is configured to cause configuration 340 of the (second) plurality of spatio-temporal filters 800, . . . , 807 with a first set of filter coefficients. To this end, the control unit 995 may be associated with (e.g., operatively connectable, or connected, to) a third configuring unit (e.g., third configuring circuitry, a third configurer). Furthermore, the control unit 995 is configured to cause determination 350 of whether reception, by the MATARA 400, of a second radio signal, different from the first radio signal, transmitted by a second remote TNode 398, 399 at a second centre frequency CF2, different from the first centre frequency CF1, during a second time period T2 following the first time period T1, is necessary. To this end, the control unit 995 may be associated with (e.g., operatively connectable, or connected, to) a first determining unit (e.g., first determining circuitry, a first determiner). Moreover, the control unit 995 is configured to cause determination 360 of whether reception, by the MATARA 400, of the first radio signal, at a third centre frequency CF3, different from the second centre frequency CF2, during a third time period T3 following the second time period T2, is necessary. To this end, the control unit 995 may be associated with (e.g., operatively connectable, or connected, to) a second determining unit (e.g., second determining circuitry, a second determiner). The control unit 995 is configured to cause, upon determining that reception of the second radio signal at the second centre frequency CF2 during the second time period T2 and/or reception of the first radio signal at the third centre frequency CF3 during the third time period T3 is necessary, configuration 370 of the (second) plurality of spatio-temporal filters 800, . . . , 807 with a second set of filter coefficients, wherein the second set of filter coefficients are selected so that signals from the first set of transceivers 500, 501 are only combined with signals from the first set of transceivers 500, 501 and signals from the second set of transceivers 514, 515 are only combined with signals from the second set of transceivers 514, 515. To this end, the control unit 995 may be associated with (e.g., operatively connectable, or connected, to) a fourth configuring unit (e.g., fourth configuring circuitry, a fourth configurer). In some embodiments, the control unit 995 is configured to cause transformation 380 of each of the (second) plurality (m) of combined signals into a frequency domain. To this end, the controlling circuitry may be associated with (e.g., operatively connectable, or connected, to) one or more transform units (e.g., transforming circuitry or the transform unit 940 or the transform sub-units thereof). Furthermore, in some embodiments the control unit 995 is configured to cause post-processing 385 of the transformed signals in the frequency domain to obtain a third plurality k of frequency domain processed signals. To this end, the controlling circuitry may be associated with (e.g., operatively connectable, or connected, to) one or more post-processing units (e.g., post-processing circuitry or the post-processing unit 960). Moreover, in some embodiments the control unit 995 is configured to cause decoding 390 of the third plurality (k) of frequency domain processed signals, thereby obtaining information signals comprising data, images, sound, voice or similar. To this end, the controlling circuitry may be associated with (e.g., operatively connectable, or connected, to) one or more decoding units (e.g., decoding circuitry or the decoder 980). In some embodiments, the control unit 995 is configured to cause checking 392 of if phase calibration information is available. To this end, the control unit 995 may be associated with (e.g., operatively connectable, or connected, to) a checking unit (e.g., checking circuitry, a cheque, or a checker). Furthermore, in some embodiments, the control unit 995 is configured to cause, if/when phase calibration information is available, performance 394 of phase calibration (and if phase calibration information is not available the control unit 995 is configured to not perform phase calibration). To this end, the control unit 995 may be associated with (e.g., operatively connectable, or connected, to) a phase calibration unit (e.g., phase calibrating circuitry, or a phase calibrator). Moreover, in some embodiments, the control unit 995 is configured to cause, after phase calibration has been performed, configuration 396 of the (second) plurality of spatio-temporal filters 800, . . . , 807 with a third set of filter coefficients, wherein the third set of filter coefficients is selected so that signals from the first set of transceivers (500, 501) are combined with signals from the first and/or the second set of transceivers (500, 501, 514, 515) and signals from the second set of transceivers (514, 515) are combined with signals from the first and/or the second set of transceivers (500, 501, 514, 515). To this end, the control unit 995 may be associated with (e.g., operatively connectable, or connected, to) a fifth configuring unit (e.g., fifth configuring circuitry, or a fifth configurer). In some embodiments, the control unit 995 (or the WD 402 or the MATARA 400) is configured to monitor only a first bandwidth part (BWP) during the first and third time periods T1, T3. To this end, the control unit 995 may be associated with (e.g., operatively connectable, or connected, to) a first monitoring unit (e.g., first monitoring circuitry, or a first monitor). Furthermore, in some embodiments, the control unit 995 (or the MATARA 400 or the WD 402) is configured to monitor only a second BWP, different from the first BWP, during the second time period T2. To this end, the control unit 995 may be associated with (e.g., operatively connectable, or connected, to) the first or a second monitoring unit (e.g., the first or a second monitoring circuitry, or the first or a second monitor).

In some embodiments, the controlling circuitry is configured to cause repetition 398 of the steps/actions 310, 320, 330, 340, 350, 360, 370 and optionally one or more of the steps/actions 380, 385, 390, 392, 394, 396, and monitor (first and/or second BWP). To this end, the controlling circuitry may be associated with (e.g., operatively connectable, or connected, to) a repetition unit (e.g., repetition circuitry or a repeater).

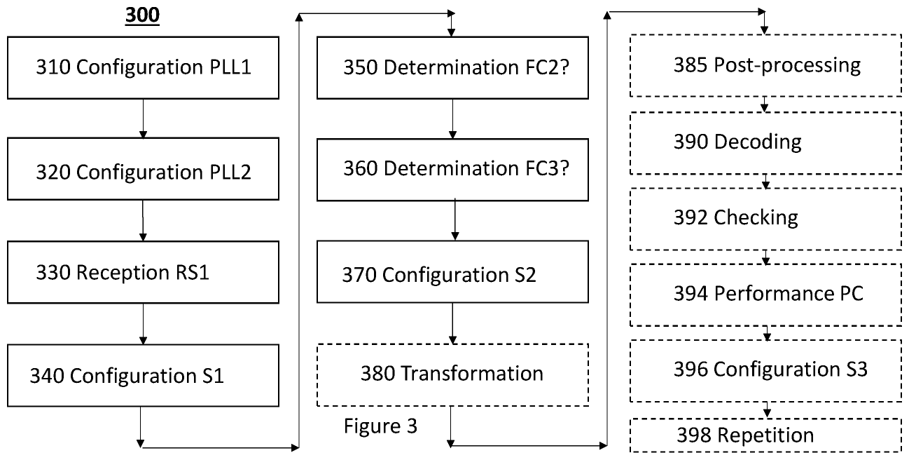

FIG. 4 illustrates different frequencies at certain points in time according to some embodiments. During a first time period T1, the WD 402 and/or the MATARA 400 receives the first radio signal at/on a first centre frequency CF1. Furthermore, during a second time period T2, the WD 402 and/or the MATARA 400 receives the second radio signal at/on a second centre frequency CF2. Moreover, during a third time period T3, the WD 402 and/or the MATARA 400 receives the first radio signal at/on a third centre frequency CF1.

FIG. 5 illustrates a system 999. The system 999 may be a wireless/cellular communication system, a cellular network, a mobile network, a telecommunications network, a cellular radio system, a digital cellular network, a mobile phone network, a mobile phone cellular network, such as 1G, 2G, 3G, 4G, 5G, 6G or similar. Furthermore, the system 999 comprises one or more wireless devices (WD) 402, 403, . . . , 408. Moreover, the system 999 comprises one or more transceiver nodes (TNodes) 397, 398, 399. The one or more transceiver nodes (TNodes) 397, 398, 399 may be base stations (gNBs, eNBs, RBS), remote radio units (RRUs), or remote wireless nodes. The WD 402 (as well as the WDs 403, . . . , 408) is, in some embodiments, configured to communicate with (e.g., send and/or receive signals, such as radio signals, e.g., comprising baseband/information signals, to/from) one or more of the remote transceiver nodes (TNodes) 397, 398, 399.

In some embodiments, the (first) plurality of transceivers 500, 501, . . . , 515 is different in number from the (second) plurality of spatio-temporal filters 800, . . . , 807, i.e., the number of transceivers 500, 501, . . . , 515 (the first plurality of transceivers) is different than/from the number of spatio-temporal filters 800, . . . , 807 (the second plurality of spatio-temporal filters 800, . . . , 807). Furthermore, in some embodiments, the (second) plurality of combined signals is equal in number to the (second) plurality of spatio-temporal filters 800, . . . , 807 (i.e., the number of combined signals is equal to the number of spatio-temporal filters 800, . . . , 807). In some embodiments, the (second) plurality of combined signals is different in number from the first plurality of digital signals (i.e., the number of combined signals is different than/from the number of digital signals). Moreover, in some embodiments, the first plurality of transceivers 500, 501, . . . , 515, the first plurality of analog radio signals, the first plurality of antenna units 700, 701, . . . , 715, and the first plurality of digital signals are equal in number (i.e., the number of transceivers 500, 501, . . . , 515, the number of analog radio signals, the number of antenna units 700, 701, . . . , 715, and the number of digital signals are all the same/equal.

### LIST OF EXAMPLES

Example 1. A method (100) of controlling a Multi-Antenna Transmitter and Receiver Arrangement, MATARA, (400), wherein the MATARA (400) is comprisable in a wireless device, WD, (402) and comprises a first plurality of transceivers (500, 501, . . . , 515), the method comprising:

configuring (110) a first PLL (520) to control centre frequency generation for a first set of transceivers (500, 501);

configuring (120) a second PLL (522) to control centre frequency generation for a second set of transceivers (514, 515);

receiving (130), by the MATARA (400), a first radio signal transmitted by a first remote transceiver node, TNode, (398), on a first centre frequency (CF1) during a first time period (T1);

configuring (140) a second plurality of spatio-temporal filters (800, . . . , 807) with a first set of filter coefficients;

determining (150) whether reception, by the MATARA (400), of a second radio signal transmitted by a second remote TNode (398, 399) at a second centre frequency (CF2), different from the first centre frequency (CF1), during a second time period (T2) following the first time period, is necessary;

determining (160) whether reception, by the MATARA (400), of the first radio signal at a third centre frequency (CF3), different from the second centre frequency (CF2), during a third time period (T3) following the second time period (T2), is necessary; upon determining that reception of the second radio signal at the second centre frequency (CF2) during the second time period (T2) and reception of the first radio signal at the third centre frequency (CF3) during the third time period (T3) is necessary, configuring (170) the second plurality of spatio-temporal filters (800, . . . , 807) with a second set of filter coefficients, wherein the second set of filter coefficients is selected so that signals from the first set of transceivers (500, 501) are only combined with signals from the first set of transceivers (500, 501) and signals from the second set of transceivers (514, 515) are only combined with signals from the second set of transceivers (514, 515).

Example 2. The method of example 1, wherein the first radio signal received during the first time period (T1) and the first radio signal received during the third time period (T3) have the same Transmission Configuration Indicator, TCI, state.

Example 3. The method of example 1 or example 2, wherein the second time period (T2) is a measurement gap.

Example 4. The method of example 1 or example 2, wherein the MATARA (400) is configured to monitor only a first bandwidth part, BWP, during the first and third time periods (T1, T3), and wherein the MATARA (400) is configured to monitor only a second BWP, different from the first BWP, during the second time period (T2).

Example 5. The method of any of examples 1-5, wherein the third centre frequency (CF3) is the same as the first centre frequency (CF1).

Example 6. A computer program product comprising a non-transitory computer readable medium (200), having stored thereon a computer program comprising program instructions, the computer program being loadable into a data processing unit (220) and configured to cause execution of the method of any of examples 1-5 when the computer program is run by the data processing unit (220).

Example 7. A control unit (995) for a Multi-Antenna Transmitter and Receiver Arrangement, MATARA, (400), wherein the MATARA (400) is comprisable in a wireless device, WD, (402), and wherein the MATARA (400) comprises: a first plurality of transceivers (500, 501, . . . , 515) configured to receive a first plurality of analog radio signals via a first plurality of antenna units (700, 701, . . . , 715); a plurality of analog to digital converters (600, 601, . . . , 615) configured to convert the first plurality of analog radio signals into a first plurality of digital signals; an extraction unit (900) configured to extract reference signals from each of the first plurality of digital signals; a channel analyzer (920) configured to determine characteristics for each of the first plurality of digital signals based on the extracted reference signals; a second plurality of spatio-temporal filters (800, . . ., 807) configured to process the first plurality of digital signals to obtain a second plurality of combined signals; a first phase lock loop, PLL, (520); and a second PLL (522); the control unit (995) configured to cause:

configuration (310) of the first PLL (520) to control the centre frequency generation for a first set of transceivers (500, 501);

configuration (320) of the second PLL (522) to control the centre frequency generation for a second set of transceivers (514, 515);

reception (330), by the MATARA (400), of the first radio signal transmitted by a first remote transceiver node, TNode, (398), on a first centre frequency (CF1) during a first time period (T1);

configuration (340) of the second plurality of spatio-temporal filters (800, . . ., 807) with a first set of filter coefficients;

determination (350) of whether reception, by the MATARA (400), of a second radio signal, different from the first radio signal, transmitted by a second remote TNode (398, 399) at a second centre frequency (CF2), different from the first centre frequency (CF1), during a second time period (T2) following the first time period (T1), is necessary; determination (360) of whether reception, by the MATARA (400), of the first radio signal, at a third centre frequency (CF3), different from the second centre frequency (CF2), during a third time period (T3) following the second time period (T2), is necessary; upon determining that reception of the second radio signal at the second centre frequency (CF2) during the second time period (T2) and reception of the first radio signal at the third centre frequency (CF3) during the third time period (T3) is necessary, configuration (370) of the second plurality of spatio-temporal filters (800, . . ., 807) with a second set of filter coefficients, wherein the second set of filter coefficients are selected so that signals from the first set of transceivers (500, 501) are only combined with signals from the first set of transceivers (500, 501) and signals from the second set of transceivers (514, 515) are only combined with signals from the second set of transceivers (514, 515).

Example 8. A Multi-Antenna Transmitter and Receiver Arrangement, MATARA, (400), wherein the MATARA, (400) is comprisable in a wireless device, WD, (402), the MATARA, (400) comprising:

a first plurality of transceivers (500, 501, . . ., 515) configured to receive a first plurality of analog radio signals via a first plurality of antenna units (700, 701, . . ., 715);

a plurality of analog to digital converters (600, 601, . . ., 615) configured to convert the first plurality of analog radio signals into a first plurality of digital signals; an extraction unit (900) configured to extract reference signals from each of the first plurality of digital signals;

a channel analyzer (920) configured to determine characteristics for each of the first plurality of digital signals based on the extracted reference signals;

a second plurality of spatio-temporal filters (800, . . . , 807) configured to process the first plurality of digital signals to obtain a second plurality of combined signals;

### A First Phase Lock Loop, Pll, (520);

### A Second Pll (522);

optionally the first plurality of antenna units (700, 701, . . ., 715); and the control unit (995) of example 8.

Example 9. A wireless device, WD, (402) comprising the multi-antenna transmitter and receiver arrangement, MATARA of example 8, (300), and the first plurality of antenna units (700, 701, . . . , 715).

### Example 10. a Chip (990) Comprising the Control Unit (995) of Example 7.

Generally, all terms used herein are to be interpreted according to their ordinary meaning in the relevant technical field, unless a different meaning is clearly given and/or is implied from the context in which it is used. Reference has been made herein to various embodiments. However, a person skilled in the art would recognize numerous variations to the described embodiments that would still fall within the scope of the claims. For example, the method embodiments described herein discloses example methods through steps being performed in a certain order. However, it is recognized that these sequences of events may take place in another order without departing from the scope of the claims. Furthermore, some actions/method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step. In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer e.g., a single) unit. Any feature of any of the embodiments/aspects disclosed herein may be applied to any other embodiment/aspect, wherever suitable. Likewise, any advantage of any of the embodiments may apply to any other embodiments, and vice versa. Hence, it should be understood that the details of the described embodiments are merely examples brought forward for illustrative purposes, and that all variations that fall within the scope of the claims are intended to be embraced therein.

### LIST OF SOME ACRONYMS AND ABBREVIATIONS THAT MAY APPEAR IN THE DESCRIPTION

3GPP—3rd Generation Partnership Project
5G—fifth generation
5G—NR (5G-New Radio) is a new RAT developed by 3GPP for the 5G mobile network
ADC—analog-to-digital converter
AGC—automatic gain controller
BB—baseband
BF—beamforming
BW—bandwidth
BWP—bandwidth part
CSI-RS—channel state information reference signal
CU—control unit
DAC—digital-to-analog converter
DCI—downlink control information
DIC—Digital Interface Chip
DL-PRS—downlink positioning reference signal
DM-RS—demodulation reference signal
DS—down-sampling
FR1—Frequency Range 1
FR1.5—Frequency Range 1.5
FR2—Frequency Range 2
Fe—Front end
FWA—Fixed Wireless Access
GNSS—Global navigation satellite system
GPS—Global Positioning System
IF—intermediate frequency
I/O—input/output
L1—Layer 1
LNA—Low Noise Amplifier
LO—Local Oscillator
LoS—Line of Sight
LTE—Long-Term Evolution
MAC—Medium Access Control
MATARA—multi-antenna transmitter and receiver arrangement
MIMO—multiple input, multiple output
mmW—millimetre wave
NAS—Non-access Stratum
nLoS—non-Line of Sight
OFDM—orthogonal frequency-division multiplexing
PA—power amplifier
PBCH—Physical Broadcast Channel
PCB—printed circuit board
PCell—primary cell
PDCCH—physical downlink control channel
PD—delay profile
PDSCH—physical downlink shared channel
PHY—Physical Layer
PLL—phase locked loop
PSCell—primary secondary cell
PSS—primary synchronization signal
PT-RS—Phase Tracking Reference signal
PUCCH—physical uplink control channel
PUSCH—physical uplink shared channel
QCL—quasi co-located
Qos—quality of service
RAT—radio access technology
RRC—radio resource control
RSRP—Reference Signal Received Power
RSRQ—Reference Signal Received Quality
RSSI—Received Signal Strength Indicator
SCell—Secondary Cell
SNR—Signal-to-noise ratio
SSB—Synchronization Signal Block
SRS—sounding reference signal
SSS—secondary synchronization signal
STEF—spatio-temporal filter
STF—spatial transmission filter
TCI—Transmission Configuration Indicator
TNode—transceiver node
VGA—variable gain amplifier
WD—wireless device

1. A method of controlling a Multi-Antenna Transmitter and Receiver Arrangement, (MATARA) wherein the MATARA is comprisable in a wireless device, (WD) and comprises a plurality of transceivers the method comprising:
configuring a first phase lock loop, (PLL) to control centre frequency generation for a first set of transceivers the first set of transceivers comprising two or more transceivers of the plurality of transceivers;
configuring a second PLL to control centre frequency generation for a second set of transceivers the second set of transceivers comprising two or more transceivers of the plurality of transceivers);
receiving, by the MATARA, a first radio signal transmitted by a first remote transceiver node, (TNode), on a first centre frequency (CF1) during a first time period (T1);
configuring a plurality of spatio-temporal filters with a first set of filter coefficients;
determining whether reception, by the MATARA of a second radio signal transmitted by a second remote TNode at a second centre frequency (CF2), different from the first centre frequency (CF1), during a second time period (T2) following the first time period, is necessary;
determining whether reception, by the MATARA of the first radio signal at a third centre frequency (CF3), different from the second centre frequency (CF2), during a third time period (T3) following the second time period (T2), is necessary;
upon determining that reception of the second radio signal at the second centre frequency (CF2) during the second time period (T2) and reception of the first radio signal at the third centre frequency (CF3) during the third time period (T3) is necessary, configuring the plurality of spatio-temporal filters with a second set of filter coefficients, wherein the second set of filter coefficients is selected so that signals from the first set of transceivers are only combined with signals from the first set of transceivers and signals from the second set of transceivers are only combined with signals from the second set of transceivers

2. The method of claim 1, wherein the plurality of transceivers is different in number from the plurality of spatio—temporal filters.

3. The method of claim 1 wherein the first radio signal received during the first time period (T1) and the first radio signal received during the third time period (T3) have the same Transmission Configuration Indicator, TCI, (TCI) state.

4. The method of claim 1 wherein the second time period (T2) is a measurement gap.

5. The method of claim 1 further comprising monitoring only a first bandwidth part, (BWP) during the first and third time periods (T1, T3) and monitoring only a second BWP, different from the first BWP, during the second time period (T2).

6. The method of claim 1 wherein the third centre frequency (CF3) is the same as the first centre frequency (CF1).

7-9. (canceled)

10. A control unit for a Multi-Antenna Transmitter and Receiver Arrangement, (MATARA) wherein the MATARA is comprisable in a wireless device, (WD) and wherein the MATARA comprises:
a plurality of transceivers configured to receive a plurality of analog radio signals via a plurality of antenna units;
a plurality of analog to digital converters configured to convert the plurality of analog radio signals into a plurality of digital signals;
an extraction unit configured to extract reference signals from each of the plurality of digital signals;
a channel analyzer configured to determine characteristics for each of the plurality of digital signals based on the extracted reference signals;
a plurality of spatio-temporal filters configured to process the plurality of digital signals to obtain a plurality of combined signals;
a first phase lock loop, (PLL); and
a second PLL;
wherein the control unit is configured to cause:
configuration of the first PLL to control a centre frequency generation for a first set of transceivers the first set of transceivers comprising two or more transceivers of the plurality of transceivers configuration of the second PLL to control a centre frequency generation for a second set of transceivers the second set of transceivers comprising two or more transceivers of the plurality of transceivers reception by the MATARA, of the first radio signal transmitted by a first remote transceiver node, (TNode), on a first centre frequency (CF1) during a first time period (T1);
configuration of the plurality of spatio-temporal filters with a first set of filter coefficients;
determination of whether reception, by the MATARA of a second radio signal, different from the first radio signal, transmitted by a second remote TNode at a second centre frequency (CF2), different from the first centre frequency (CF1), during a second time period (T2) following the first time period (T1), is necessary;
determination of whether reception, by the MATARA of the first radio signal, at a third centre frequency (CF3), different from the second centre frequency (CF2), during a third time period (T3) following the second time period (T2), is necessary;
upon determining that reception of the second radio signal at the second centre frequency (CF2) during the second time period (T2) and reception of the first radio signal at the third centre frequency (CF3) during the third time period (T3) is necessary, configuration of the plurality of spatio-temporal filters with a second set of filter coefficients, wherein the second set of filter coefficients are selected so that signals from the first set of transceivers are only combined with signals from the first set of transceivers and signals from the second set of transceivers are only combined with signals from the second set of transceivers

11. The control unit of claim 10, wherein the plurality of combined signals is equal in number to the plurality of spatio-temporal filters and wherein the plurality of combined signals is different in number from the plurality of digital signals.

12. The control unit of claim 11, wherein the plurality of transceivers, the plurality of analog radio signals, the plurality of antenna units, and the plurality of digital signals are equal in number.

13. A Multi-Antenna Transmitter and Receiver Arrangement, (MATARA), wherein the MATARA, is comprisable in a wireless device, (WD), the MATARA, comprising the control unit of claim 10.

14. The MATARA of claim 13, further comprising:
a plurality of transceivers configured to receive a plurality of analog radio signals via a plurality of antenna units;
a plurality of analog to digital converters configured to convert the plurality of analog radio signals into a plurality of digital signals;
an extraction unit configured to extract reference signals from each of the plurality of digital signals;
a channel analyzer configured to determine characteristics for each of the plurality of digital signals based on the extracted reference signals;
a plurality of spatio-temporal filters configured to process the plurality of digital signals to obtain a plurality of combined signals;
a first phase lock loop, (PLL); and
a second PLL

15. The MATARA of claim 14, further comprising:
the plurality of antenna units

16. The MATARA of claim 13, wherein the MATARA is configured to monitor only a first bandwidth part, (BWP) during the first and third time periods (T1, T3), and wherein the MATARA is configured to monitor only a second BWP, different from the first BWP, during the second time period (T2).

17-18. (canceled)
